(19) United States
(12) Patent Application Publication
(10) Pub. No.: US 2016/0193820 A1
(43) Pub. Date: Jul. 7, 2016

(54) Coloured carbon-fibre composite materials

(71) Applicant: GPFone Limited, London (GB)

(72) Inventor: Harry Street, Tingewick (GB)

(73) Assignee: GPFone Limited, London (GB)

(21) Appl. No.: 14/911,525

(22) PCT Filed: May 8, 2014
(86) PCT No.: PCT/GB2014/051411

§ 371 Date: Feb. 11, 2016

(30) Foreign Application Priority Data
May 8, 2013 (GB) 1308284.7

(51) Int. Cl. B32B 37/18; B32B 27/12

(52) U.S. Cl. CPC B32B 37/182; B32B 27/12; B32B 2307/402; B32B 2305/08; B32B 2305/74; B32B 2313/04; B32B 2307/414

(57) ABSTRACT

A coloured composite material and method of manufacture. A coloured finish composite is applied to a structural composite core and cured as a single article resulting in a composite material having structural integrity and a coloured finish. In a preferred embodiment, the coloured finish composite is formed into a required shape, prior to being applied to the structural composite core.

### BACKGROUND

This invention relates to composite materials incorporating a coloured appearance and processes for the manufacture thereof.

Composite materials, and in particular carbon fibre composites, are a family of materials that have become exceptionally popular due to their structural properties. Composite materials have a high strength to weight ratio and are highly versatile. Composite materials are formed of a fibrous reinforcement material embedded within a matrix material. A common example is a woven carbon fibre mat embedded in an epoxy-based matrix. Carbon fibre composites are used extensively in high performance industries such as motorsport and aviation.

Composite materials have a very distinctive appearance due to the woven structure of the fibrous reinforcement material. This appearance has become desirable due to its association with high-performance products formed of composite materials. However, the appearance is currently restricted to the colour of carbon fibres which are black. The material is therefore not attractive to the creative industries.

Extensive work has been performed to produce a composite material with a bright colour, while retaining the distinctive woven fibre appearance. To date such efforts have not realised a material which retains the structural properties of a composite material and which has a finish of a suitable quality for association with high performance and high quality products.

A principle route of investigation has been to use a mixture of coloured and carbon fibres for the formation of a composite material in the hope this will provide a finished composite material with the required appearance. However, the coloured fibres utilised in this approach are formed of glass materials which do not have the structural advantages of carbon. The resulting material thus loses the structural benefits of carbon fibre composites. The material also does not have a uniform appearance as the weave is a mixture of black carbon fibres and coloured fibres. While the pattern may be attractive in some ways, this is not the desired appearance. Furthermore, when the coloured fibres are encased in the matrix the colours are dulled by the matrix material and the natural colouring of the fibres is lost. It has not proved possible to obtain a finished composite material with the coloured finishes required.

There is therefore a requirement for improved coloured carbon fibre composites.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

There is provided a process for the manufacture of a coloured composite structure, comprising the steps of forming a coloured composite sheet material into a required shape, the coloured composite sheet material comprising a layer of a coloured translucent material and a layer of a fibrous material on a first face of the layer of coloured translucent material, wherein the second face of the layer of coloured translucent material forms a viewable face, adhering a first face of an uncured composite sheet material to the side of the fibrous material away from the coloured translucent material, and curing the composite structure.

There is provided a coloured composite material, comprising an outer layer of a coloured translucent material, a layer of fibrous material adhered to the inner face of the coloured translucent material, and a composite material adhered to the face of the fibrous material which is not adhered to the coloured translucent material.

A selection of optional features are set out in the dependent claims.

The preferred features may be combined as appropriate, as would be apparent to a skilled person, and may be combined with any of the aspects of the invention.

### BRIEF DESCRIPTION OF THE DRAWINGS

Embodiments of the invention will be described, by way of example, with reference to the following drawings, in which:

FIG. 1 shows a cross-section of a composite material, and

FIG. 2 shows a process for the manufacture of a coloured composite material.

### DETAILED DESCRIPTION

Embodiments of the present invention are described below by way of example only. These examples represent the best ways of putting the invention into practice that are currently known to the Applicant although they are not the only ways in which this could be achieved. The description sets forth the functions of the example and the sequence of steps for constructing and operating the example. However, the same or equivalent functions and sequences may be accomplished by different examples.

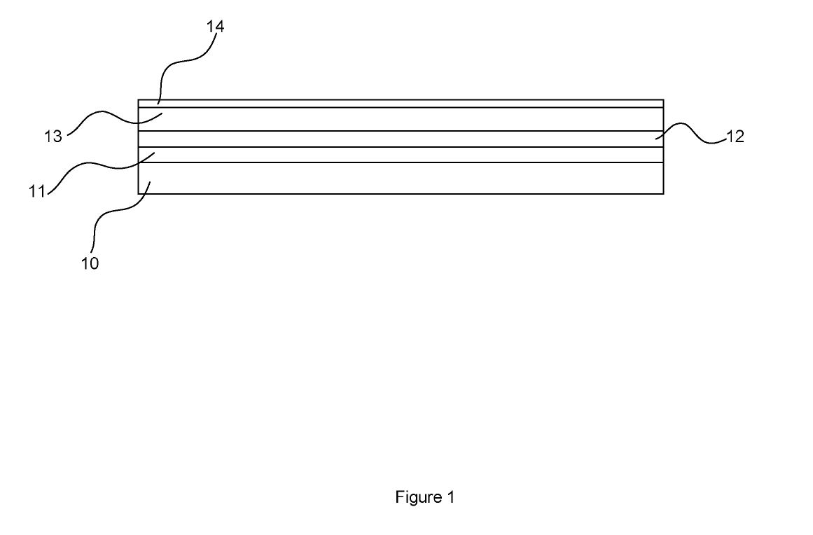

FIG. 1 shows a cross-section through a coloured carbon fibre material which retains the structural qualities of conventional carbon fibre composites, but provides a high-quality coloured appearance.

A conventional carbon fibre composite 10 forms a first layer of the material. A bonding film 11 at least partially covers a first surface of the carbon fibre 10 to which is bonded a fibrous layer 12. The fibrous layer 12 is covered with a coloured finish coat 13. The surface of the finish coat 13 may be covered with a lacquer 14 to further improve the appearance and surface finish qualities. In an alternative structure layers 12 and 13 may be formed of a single layer, or a composite of non-fibrous layers to give the required appearance. For example, a plastic sheet material may be formed to provide the appearance of fibres embedded in a matrix. In an example a sheet of PVC/PU (without phthalates) in a ratio of 96/4 may be utilised.

The composite of FIG. 1 is provided with its structural properties by the carbon fibre composite 10 which is formed in the conventional manner. The composite thus allows a material having the required structural properties to be produced which also has the required appearance as provided by the finish coat 13.

Fibrous layer 12 is woven to provide the required appearance. For example, the ‘classic’ carbon fibre appearance is a 2/2 weave. Fibrous layer 12 may be formed of glass fibres which in their natural state have a silver or white colour. This layer forms a backing to the finish coat 13 and the bright, neutral, colour of the backing improves the colour appearance of the finished product. The fibrous layer may also be formed of materials contributing to the appearance of the composite, for example metal fibres may be woven into, or used exclusively.

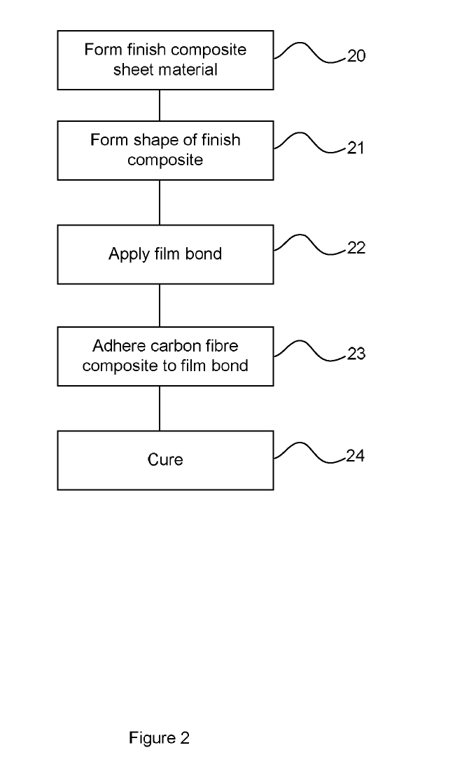

FIG. 2 shows a flow chart of a production process for the composite material shown in FIG. 1.

At step 20 a finish composite is formed by depositing finish coat 13 on to fibrous layer 12. Fibrous layer 12 may be a glass fibre woven material. Since fibrous layer 12 is not the principle structural component of the resulting compositing the particular weave can be defined according to the aesthetic requirements as opposed to structural requirements. Finish coat 13 may be formed of a plastic material which is applied to the fibrous layer 12 using an appropriate technique. Preferably the material is of a type which is malleable at a convenient working temperature to ease the further steps of the process to incorporate the finish composite with a structural composite.

The finish coat 13 and fibrous layer 12 cooperate to provide the required colour and patterning in the finished product.

At step 21 the finish composite is formed into the required shape by laying the material in a mould. The finish composite may be cured into that shape using heat and/or vacuum to ensure a good fit with the mould and the required surface finish. In an example the material may be heated to 50° C. to soften the finish coat 13 and allow formation into the required mould shapes. In order to obtain the required conformity to the mould an intensifier, for example a silicon mandrel or match-moulded component, may be utilised to compress the finished composite against the mould.

At step 22 an adhesive film bond is adhered to the fibrous layer 12 on the other side of that layer to the finish coat 13.

At step 23 a layer of carbon fibre pre-preg is laid up over the finish composite and adhered to the film bond. A conventional lay-up and shaping process is utilised to achieve a continuous bond between the pre-preg and the finish composite layers. For example, vacuum bagging techniques may be utilised.

At step 24 the composite is cured according to a defined process to cure the pre-preg matrix material and the adhesive layer. Depending on the material, the finish composite may also be cured or set during this period.

The parameters of the cure cycle define the properties of the final product's structural and aesthetic properties. For example, the temperature must be sufficient to cure the matrix material, but sufficiently low to avoid damage to the finish coat 13. It has been observed that excessive temperatures may result in discolouration of the finish coat or transfer of the matrix and finish coat through the fibrous layer result in colour degradation. The temperature must also be sufficiently high to avoid an excessively long cure time which leads to increased manufacturing costs and can result in degradation of the materials.

It has been identified that so-called low-temperature curing resins are particularly appropriate for this application as the resin can be reliably cured at a temperature that does not degrade the other components of the material.

The cure cycle is defined to provide the optimum balance of curing the composite matrix, without degrading the finish composite. In an example an LTM material is cured at a temperature of 77° C. for a period of 8 hours. A range of 65 to 80° C. may be appropriate. During experimentation temperatures below 65° C. were found to take took long to cure and formation of corners was unreliable. At temperatures over 80° C. colour loss occurred.

In experiments the cure cycle was conducted in an autoclave at 30 psi to assist in consolidation of the material layers. It was found that higher pressures led to deformation of the surface and an imprint of sub layers could be seen in the surface finish.

In a further example, a second finish composite may be applied to the reverse side of the carbon fibre composite layer to provide a material with a double-side finish. Appropriate forming and processing steps are utilised to provide the required finish on both faces.

At step 25 a lacquer layer is applied to the surface of the material to provide the required appearance and surface finish. The material of the finish coating may be a plastic which is softer than conventional matrix materials and thus a thick and hard lacquer may be required to give the require finish. It has also been identified that the visual appearance of the material may be improved by correct lacquer application. For example, a two pack hard lacquer may be sprayed on to the surface and baked to cure. Multiple cycles of polish and application may be applied to build the required finish.

A carbon fibre composite having a coloured surface finish has thus been described, where that coloured finish retains the aesthetic appeal of carbon fibre weaves.

When forming an article pieces of the finish composite having different colours may be applied to provide a pattern, logo, or image, in those colours within the composite material. Furthermore, the finish composite may be manufactured to having regions of different colours to forms patterns, logos, or images without having to lay up multiple pieces of the material.

Any range or device value given herein may be extended or altered without losing the effect sought, as will be apparent to the skilled person.

It will be understood that the benefits and advantages described above may relate to one embodiment or may relate to several embodiments. The embodiments are not limited to those that solve any or all of the stated problems or those that have any or all of the stated benefits and advantages.

Any reference to an item refers to one or more of those items. The term ‘comprising’ is used herein to mean including the method blocks or elements identified, but that such blocks or elements do not comprise an exclusive list and a method or apparatus may contain additional blocks or elements.

The steps of the methods described herein may be carried out in any suitable order, or simultaneously where appropriate. Additionally, individual blocks may be deleted from any of the methods without departing from the spirit and scope of the subject matter described herein. Aspects of any of the examples described above may be combined with aspects of any of the other examples described to form further examples without losing the effect sought.

It will be understood that the above description of a preferred embodiment is given by way of example only and that various modifications may be made by those skilled in the art. Although various embodiments have been described above with a certain degree of particularity, or with reference to one or more individual embodiments, those skilled in the art could make numerous alterations to the disclosed embodiments without departing from the spirit or scope of this invention.

1. A process for the manufacture of a coloured composite structure, comprising the steps of
forming a coloured composite sheet material into a required shape, the coloured composite sheet material comprising a layer of a coloured translucent thermoplastic material and a layer of a fibrous material on a first face of the layer of coloured translucent material, wherein the second face of the layer of coloured translucent material forms a viewable face,
adhering a first face of an uncured composite sheet material to the side of the fibrous material away from the coloured translucent material, and
curing the coloured composite sheet material and the uncured composite sheet material during the same time period to form the composite structure.

2. The process of claim 1, further comprising the steps of
prior to curing, adhering a second coloured composite sheet material to a second face of the uncured composite sheet material, wherein the second coloured composite sheet material comprises a second layer of a coloured translucent material and a second layer of a fibrous material on a first face of the second layer of coloured translucent material, the fibrous material of the second coloured translucent material being adhered to the second face of the uncured composite sheet material, wherein the second face of the second layer of coloured translucent material forms a viewable face.

3. The process of claim 1, wherein the first and/or second coloured composite sheet materials are adhered to the uncured composite sheet material using a film bond.

4. The process of claim 1, wherein the composite sheet material is a carbon fibre composite.

5. The process of claim 1, wherein the step of curing is performed at a temperature in the range of 65 to 80° C.

6. The process of claim 5, wherein the step of curing is performed at a temperature in the range of 75 to 80° C.

7. The process of claim 6 wherein the step of curing is performed at a temperature of 77° C.

8. The process of claim 1, wherein the matrix material of the uncured composite sheet material is a low temperature material.

9. The process of claim 1, wherein the step of curing is performed for a period in the range of 4 to 10 hours.

10. The process of claim 9 wherein the step of curing is performed for a period in the range of 6 to 8 hours.

11. The process of claim 1, wherein the fibrous material of the coloured composite sheet material comprises glass fibres.

12. The process of claim 1, wherein the fibrous material of the coloured composite sheet material comprises glass fibres of a white or silver colour.

13. The process of claim 1, wherein the fibrous material of the coloured composite sheet material is a woven material.

14. The process of claim 1, wherein the fibrous material of the coloured composite sheet material is woven in a 2/2 pattern.

15. (canceled)

16. (canceled)

17. A coloured composite structure, comprising:
an outer layer of a coloured translucent thermoplastic material, a layer of fibrous material adhered to the inner face of the coloured translucent thermoplastic material, and
a composite material adhered to the face of the fibrous material which is not adhered to the coloured translucent material, wherein the composite material, the fibrous material and the outer layer are heated in a curing process after the composite material is adhered to the fibrous material and the fibrous material is adhered to the outer layer.

18. The coloured composite material of claim 17, wherein the composite material is a carbon fibre composite.

19. The process of claim 1, wherein the step of forming the coloured composite sheet material into a required shape is performed by laying the material in a mould, the step of adhering the first face of the uncured composite material to the side of the fibrous material away from the coloured translucent material is performed in the mould, and the step of curing is performed in the mould.
